(19) United States
(12) Patent Application Publication
(10) Pub. No.: US 2007/0002095 A1
(43) Pub. Date: Jan. 4, 2007

(54) Image forming apparatus and program

(75) Inventors: Kenichi Ozawa, Tokyo (JP); Hiroyuki Arai, Tokyo (JP); Chikatsu Suzuki, Tokyo (JP); Ken Miyazaki, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/408,264

(22) Filed: Apr. 20, 2006

(30) Foreign Application Priority Data
Jun. 30, 2005 (JP) JP2005-191887

(51) Int. Cl. B41J 23/00

(52) U.S. Cl. 347/37

(57) ABSTRACT

An image forming apparatus, comprising: a control device which controls forming of a marginal area at least on one of sides of a recording medium in a full bleed printing mode, in which a toner image is formed and outputted based on an image data whose size is greater than that of a recording medium used for image forming through electricphotographing process on an entire area of the recording medium.

### FIELD OF THE INVENTION

The present invention relates to an image forming apparatus and program provided with a full bleed printing mode.

### BACKGROUND OF THE INVENTION

According to the conventional art, in an image forming apparatus based on the electrophotographic process, an image is formed based on the image data having the size greater than that of the transfer sheet, when the full bleed printing mode is used wherein printing is performed up to the very edge of a transfer sheet as a recording medium. This results in the toner coming off the edge of a transfer sheet.

FIG. 12 schematically shows the transfer section in the color image forming apparatus based on electrophotographic process. In the color image forming apparatus based on the electrophotographic process, the transfer sheet is conveyed as it is synchronized with the toner image transferred from the photoreceptor drum to the intermediate transfer belt. When the transfer sheet has passed through the pressure section of the secondary transfer roller, the toner image on the intermediate transfer belt is transferred to the transfer sheet. In this case, the toner coming off the edge of a transfer sheet is transferred to the secondary transfer roller, as shown in FIG. 12. This will contaminate the rear and end face of the transfer sheet, with the result that the image quality is deteriorated. Especially, the toner coming off the leading edge of the transfer sheet will adhere to the secondary transfer roller, and will contaminate the rear of the transfer sheet directly.

Increase in the amount of the toner coming off the edge of the transfer sheet signifies increased waste of toner. This raises the problem of unwanted cost increase. Further, this means an unwanted waste of the material for cleaning the transfer section such as an intermediate transfer belt and secondary transfer roller, and hence a prolonged cleaning time and reduced productivity.

One of the efforts for solving this problem is disclosed, for example, in the Patent Document 1, wherein sheet edge and skew are detected in the borderless printing mode or in the full bleed printing mode, and the image size is changed in response to the result of detection, whereby an image is formed.

[Patent Document 1] Official Gazette of Japanese Patent Tokkai 2004-341051

In the Patent Document 1 solves the problem wherein a margin is produced in the sheet having been formed by sheet edge and skew. However, it fails to solve the problem wherein the toner coming off the edge of a transfer sheet transfers to the transfer section and the rear of the transfer sheet is contaminated by the toner having been transferred to the transfer section.

### SUMMARY OF THE INVENTION

An object of the present invention is to prevent contamination of the recording medium caused by the toner coming off the edge of the recording medium in the full bleed printing mode through the electrophotographic process, and to ensure improved quality of the finished form.

The above-mentioned problems are solved by the following items:

An image forming apparatus, comprising:

a control device which controls forming of a marginal area at least on one of sides of a recording medium in a full bleed printing mode, in which a toner image is formed and outputted based on an image data whose size is grater than that of a recording medium used for image forming through electricphotographing process on an entire area of the recording medium.

A computer program for controlling an image forming apparatus, comprising the function of:

a marginal area forming function which realizes the image forming apparatus to control forming of the marginal area at least on one of sides of the recording medium in a full bleed printing mode, in which a toner image is formed and outputted based on an image data whose size is grater than that of a recording medium used for image forming through electricphotographing process on an entire area of the recording medium.

### BRIEF DESCRIPTION OF THE DRAWINGS

FIG. 1 is a block diagram representing the functional structure of the image forming apparatus 1 of an embodiment of the present invention;

FIG. 2 is a diagram showing the relationship between the image data used for full bleed printing and transfer sheet arrangement area corresponding to the transfer sheet in the image data area.

FIG. 3 is a diagram showing an example of the full bleed setting screen 121;

FIG. 4 is a diagram showing an example of the full bleed offset adjustment screen 122;

FIG. 5 is a diagram showing the structure of the major components of the printer section 105;

FIG. 6 is a diagram showing an example of storing the data of the variation parameter storage section 107a;

FIG. 7 is a diagram showing the processing of image formation control to be implemented by the CPU 101;

FIG. 8 is a flow chart showing the image trimming operation to be performed by the CPU 101;

FIG. 9 is a flow chart showing the processing of determining the position for the image leading edge trimming to be implemented by the CPU 101;

FIG. 10 is a diagram showing the position of the image leading edge trimming in the image data for full bleed printing;

FIG. 11 is a diagram showing the relationship between the toner image and transfer sheet at the time of transfer in the printer section 105; and

FIG. 12 is a diagram schematically showing the transfer section in the color image forming apparatus based on electrophotographic process.

### DESCRIPTION OF THE PREFERRED EMBODIMENT

The following describes the details of the embodiments of the present invention with reference to drawings. The structure will be described in the first place.

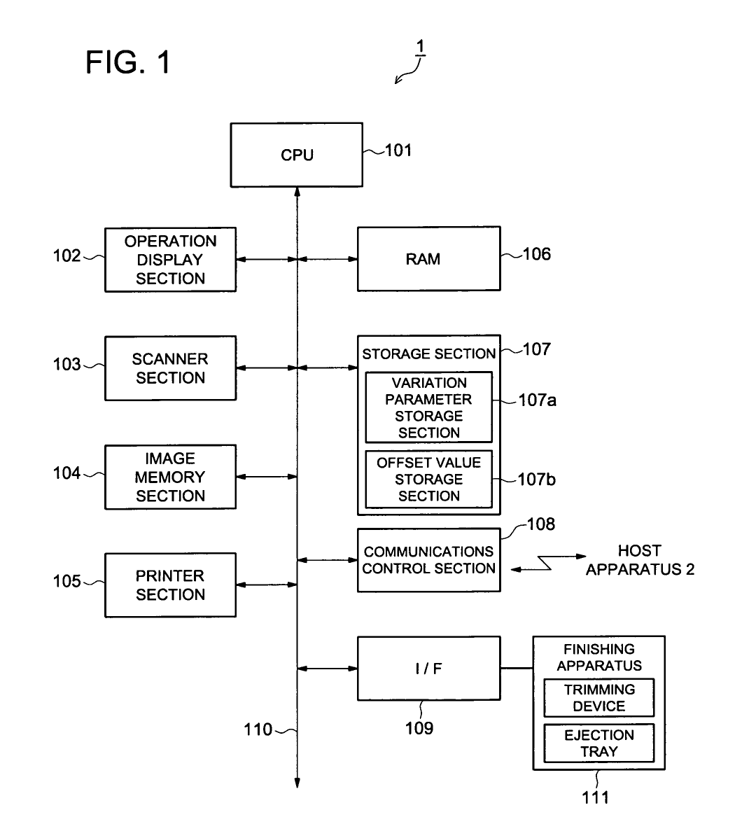

FIG. 1 shows an example of the structure inside image forming apparatus 1 of the embodiment of the present invention. Image forming apparatus 1 is a color image forming apparatus for forming an image on the transfer sheet as a recording medium for example, according to the electrophotographic process, and outputting the same. As shown in FIG. 1, image forming apparatus 1 includes CPU 101, operation display section 102, scanner section 103, image memory section 104, printer section 105, RAM 106, storage section 107, communications control section 108, interface 109 and others. These components are connected via the bus 110. Image forming apparatus 1 is connected with finishing apparatus 111 through the interface 109.

When operation display section 102 is operated, the CPU (Central Processing Unit) reads the system program, image formation control processing program, first and second image processing programs, image trimming program and various other processing programs stored in storage section 107, and develops them on the RAM. The operations of the components of image forming apparatus 1 are centrally controlled according to the program developed on the RAM.

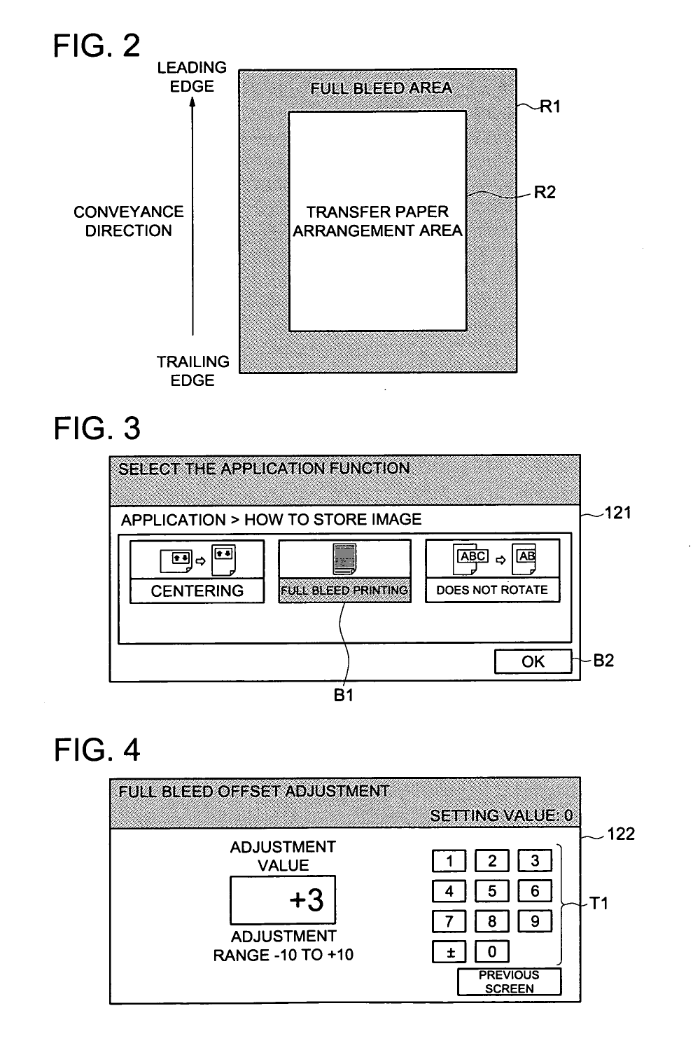

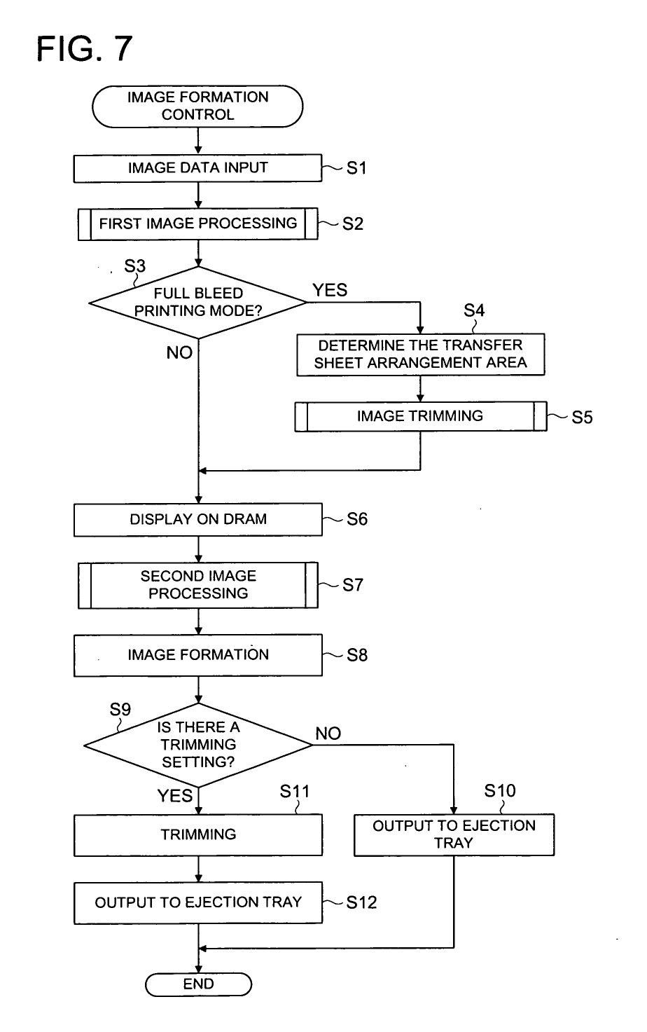

For example, when the full bleed printing mode is specified according to the input from full bleed setting screen 121 (FIG. 3) of operation display section 102 and the control data received from the host apparatus 2 via communications control section 108, CPU 101 sets the operation mode to the full bleed printing mode, and implements image trimming in the step of image formation control processing (FIG. 7) (to be described later).

The full bleed printing mode in the sense in which it is used here refers to the mode of printing an image on the transfer sheet based on the image data having a size greater than that of the transfer sheet. In the full bleed printing mode, an image is formed in almost all the areas of the transfer sheet. For example, when the full bleed printing mode has been set from host apparatus 2, a full bleed print image having a size greater than that of the transfer sheet is generated at host apparatus 2. The image data having been generated is then sent to image forming apparatus 1. When the image read from scanner section 103 is printed in the full bleed mode, the transfer sheet smaller than the image having been read is conveyed, whereby full bleed printing is implemented. When a document image having the same size as the transfer sheet has been read, the read image can be enlarged to form the image for full bleed printing.

FIG. 2 shows the relationship between the image data used for full bleed printing and transfer sheet arrangement area in the image data area. The area R1 in FIG. 2 is the area of the image data for full bleed printing (full bleed area). Area R2 indicates the image data area (hereinafter referred to as “transfer sheet arrangement area”) corresponding to the transfer sheet in the process of image formation in the full bleed area. The size of the transfer sheet arrangement area is the same as that of the transfer sheet used for image formation. In the full bleed printing mode, the CPU 101 controls each component of printer section 105 for image formation in such a way that the transfer sheet will match the toner image corresponding to the transfer sheet arrangement area. When an image is formed and transferred without any individual difference and variations among machines, the size and position of the toner image corresponding to this transfer sheet arrangement area match the size and position of the transfer sheet.

In the present embodiment, the transfer sheet arrangement area is determined in such a way that the center of the transfer sheet arrangement area will match the center of the full bleed area, without the present invention being restricted thereto. For example, the leading edge of the full bleed area can be made to match that of the transfer sheet arrangement area.

The direction of the leading edge of the image data (full bleed area, transfer sheet arrangement area) refers to the direction of the leading edge relative to the transfer sheet conveyance direction when a toner image is formed based on the image data in the process of image formation. The direction of the trailing edge of the image data (full bleed area, transfer sheet arrangement area) refers to the direction of the trailing edge relative to the transfer sheet conveyance direction when a toner image is formed based on the image data in the process of image formation (FIG. 2). The direction of the leading edge of the transfer sheet refers to the direction of the leading edge relative to the transfer sheet conveyance direction in the process of image formation. The direction of the trailing edge of the transfer sheet refers to the direction of the trailing edge relative to the transfer sheet conveyance direction in the process of image formation.

Operation display section 102 is made up of an LCD (Liquid Crystal Display). According to the instruction of the display signal inputted from the CPU 101, operation display section 102 displays full bleed setting screen 121 (FIG. 3) for the user to set the full bleed printing mode, full bleed offset adjustment screen 122 (FIG. 4) for inputting the full bleed offset adjustment value, the full bleed detail setting screen (not illustrated) and many others. The LCD display screen is covered with a pressure sensitive (resistive film pressure type) touch panel formed by the transparent electrodes arranged in a grid pattern. The X-Y coordinates of the stressed point depressed by a finger or touch pen are detected in terms of voltage values. The position signal having been detected is outputted to CPU 101 as an operation signal.

FIG. 3 shows an example of full bleed setting screen 121. When full bleed print button B1 has been selected in full bleed setting screen 121 and the OK button B2 has been depressed, the operation mode of the image forming apparatus 1 is set to the full bleed printing mode. FIG. 4 shows an example of full bleed offset adjustment screen 122 as an adjusting device. Numeric key group T1 is indicated on full bleed offset adjustment screen 122. The user can adjust the width of the marginal area to be formed in the full bleed printing mode (width of the marginal area from the side of the leading edge of the transfer sheet) by operating this numeric keypad T1 to enter the offset value. The width of the marginal area is increased by adjusting the offset value to the positive side, and is decreased by adjusting it to the negative side. The offset value having been inputted is stored in the offset value storage section 107b of storage section 107, and is set as the offset value for the width of the marginal area formed on the leading edge of the transfer sheet. The offset value can be inputted from full bleed offset adjustment screen 122 in such a way that the toner image will run off the leading edge of the transfer sheet, and the width of the toner image off the leading edge of the transfer sheet can also be adjusted. When the user is not concerned about the contamination on the rear of the transfer sheet, adjustment is made so that the toner image run off the leading edge of the transfer sheet. This adjustment ensures printing to be made over the entire area of the transfer sheet, despite individual differences among machines or variations.

the full bleed detailed setting screen (not illustrated) is used to make detailed settings for full bleed printing. For example, it is used to set the function of trimming the marginal area on the leading edge of the transfer sheet in the conveyance direction.

Scanner section 103 is provided with the scanner on the lower portion of the contact glass where a document is placed. It is used to read the image of the document. The scanner is made of the light source, CCD (Charge Coupled Device), A/D converter and others. The light applied to scan the document from the light source is reflected to form an image, After photoelectric conversion, the document image is read in the form of R, G and B signals. The image having been read is subjected to analog-to-digital conversion and is outputted to CPU 101.

Image memory section 104 is made of a DRAM (Dynamic Random Access Memory) and others and stores the image data to be inputted, under the control by CPU 101.

Printer section 105 forms a toner image on the transfer sheet according to the electrophotographic process, based on the image data inputted from CPU 101, and outputs it.

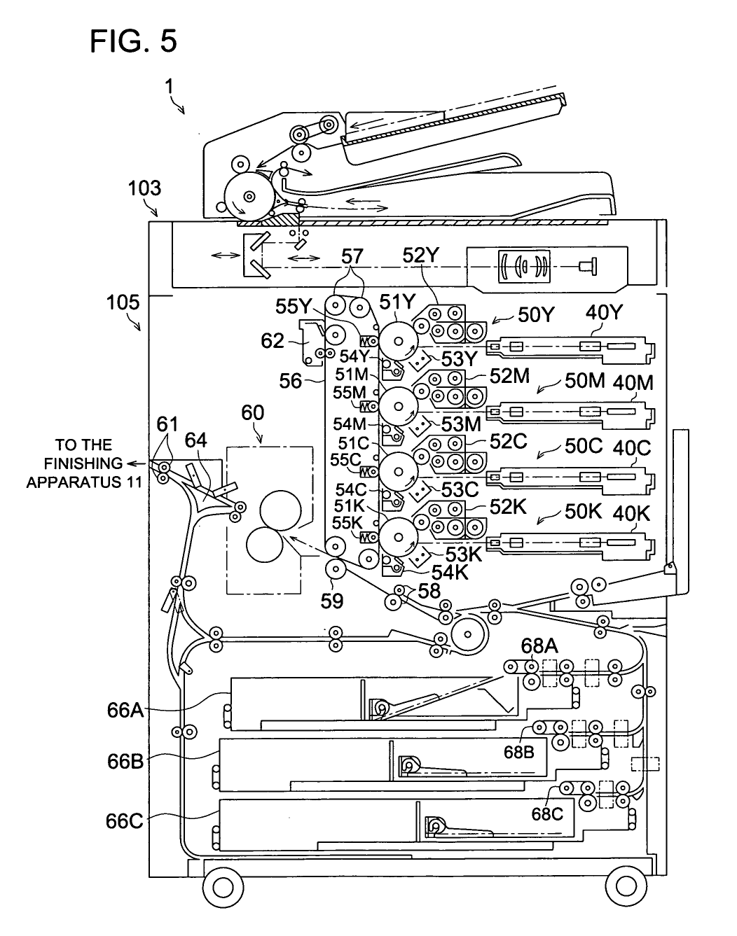

FIG. 5 shows the structure of the major components of printer section 105. As shown in FIG. 5, printer section 105 includes:

writing units 40Y, 40M, 40C and 40K as writing means wherein the PWM (Pulse Width Modulation) signal is generated by a pulse width modulator (not illustrated) according to the Y, M, C and K-image data having been inputted, laser light is applied to the photoreceptor drum 51Y, 51M, 51C and 51K according to this PWM signal, and a latent image is written on the photoreceptor drum;

photoreceptor units 50Y, 50M, 50C and 50K for forming the Y, M, C and K toner images;

an intermediate transfer belt 56 as an intermediate transfer member for conveying the toner images formed at the photoreceptor units 50Y, 50M, 50C and 50K, to the transfer sheet rotatably by roller 57;

registration roller 58 for synchronizing the transfer sheet with the toner image formed on intermediate transfer belt 56 and conveying it to secondary transfer roller 59;

secondary transfer roller 59 for transferring the toner image formed on intermediate transfer belt 56, onto the transfer sheet;

fixing unit 60 for fixing the toner image to the transfer sheet; and

sheet ejection roller 61 for ejecting the transfer sheet.

Photoreceptor unit 50Y contains photoreceptor drum 51Y, development device 52Y, charging device 53Y, cleaner 54Y and primary transfer roller 55Y. In the same manner, the photoreceptor units 50M, 50C and 50K also contain the corresponding devices.

The following describes the procedure of image formation in printer section 105. In photoreceptor unit 50Y, photoreceptor drum 51Y rotates and the surface thereof is charged by charging device 53Y. When the laser light source of the writing unit 40Y is applied, the latent image of the Y data is formed on the charged portion. The yellow toner image is formed on the portion of latent image by development device 52Y. The toner image is transferred to intermediate transfer belt 56 by the contact pressure of primary transfer roller 55Y (primary transfer). The toner image becomes the yellow image corresponding to the image data to be outputted. The toner not having been transferred is removed by cleaner 54Y.

The above description also applies to photoreceptor units 50M, 50C and 50K. The magenta toner image, cyan toner image and black toner image are formed and transferred in the similar manner. Intermediate transfer belt 56 is rotated by the rotation of the roller 57, primary transfer roller 55Y, 55M, 55C and 55K and secondary transfer roller 59. The Y, M, C and K toner images are superimposed on intermediate transfer belt 56 one after another. The transfer sheets are conveyed one by one from any one of sheet feed trays 66A through 66C by the rotation of any one of sheet feed rollers 68A through 68C. They are conveyed to secondary transfer roller 59 by the rotation of registration roller 58.

When the transfer sheet passes through the pressure section of secondary transfer roller 59, the Y, M, C and K toner images on intermediate transfer belt 56 are transferred onto the transfer sheet (secondary transfer). The transfer sheet on which the Y, M, C and K toner images have been transferred passes through fixing unit 60. The Y, M, C and K toner image is fixed on the transfer sheet by the pressure and heat applied by the fixing unit 60, and color toner images are formed. The transfer sheet with an image formed thereon is conveyed to finishing apparatus 111 by the sheet ejection roller 61.

After formation of the image on the transfer sheet, toner is removed from the intermediate transfer belt 56 by the belt cleaning 62. Positive and negative currents are alternately applied to the secondary transfer roller 59 with a power source (not illustrated) for a predetermined period of time. Toner deposited on secondary transfer roller 59 is transferred to intermediate transfer belt 56, and secondary transfer roller 59 is cleaned.

The aforementioned components of printer section 105 are driven under the control of CPU 101 through various motors (not illustrated). The operation timing of these components is controlled by CPU 101.

In various steps of processing implemented and controlled by the CPU 101, the RAM 106 provides a temporary storage area for storing the program read from the storage section 107 and the data and parameters inputted or outputted.

Storage section 107 includes a nonvolatile semiconductor memory and others. It stores the system program conforming to image forming apparatus 1, image formation control processing program that can be implemented on the system program, the first and second image processing program, image trimming program, and various other processing programs. The programs are stored in the form of program codes readable to the computer. CPU 101 implements operations according to the program codes. Further, storage section 107 is provided with a variation parameter storage section 107a and offset value storage section 107b.

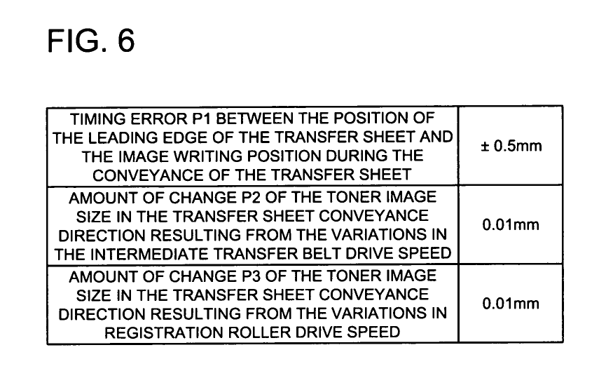

FIG. 6 shows an example of storing the data of variation parameter storage section 107a. Variation parameter storage section 107a stores the data on variations (amounts of change) that occur to the leading edge position of the transfer sheet subsequent to image formation. As shown in FIG. 6, variation parameter storage section 107a stores the timing error P1 between the position of the leading edge of the transfer sheet and the image writing position during the conveyance of the transfer sheet; the amount of change P2 in the toner image size in the transfer sheet conveyance direction resulting from the variations in the intermediate transfer belt drive speed; and the amount of change P3 in the toner image size in the transfer sheet conveyance direction resulting from the variations in registration roller drive speed.

Offset value storage section 107b stores the offset value, provided on the leading edge of the transfer sheet arrangement area, having been inputted through full bleed offset adjustment screen 122.

The aforementioned P2 is defined as the amount of change in the toner image size in the transfer sheet conveyance direction resulting from the variations in the toner image conveyance speed. For example, when the toner image formed on the photoreceptor drum is transferred to the transfer sheet directly without using the intermediate transfer belt, the P2 is the amount of change in the toner image size in the transfer sheet conveyance direction resulting from the variations in the drive speed of the photoreceptor drum. The P3 is defined as the amount of change in the toner image size in the transfer sheet conveyance direction resulting from the variations in the transfer sheet conveyance speed.

Communications control section 108 includes a LAN adaptor and rooter, and is used to exchange data with the host apparatus 2 and various other apparatuses via the communications line such as LAN (Local Area Network).

Interface 109 is used to control the exchange of control signal and data between CPU 101 and CPU (not illustrated) of finishing apparatus 111 by serial communications.

Finishing apparatus 111 includes a trimming device formed of an upper trimming blade (not illustrated), lower trimming blade, movable plate, pressure roller, drive means and others; and a sheet ejection tray. According to the control signal of CPU 101 inputted through interface 109, finishing apparatus 111 trims off the marginal area of the transfer sheet where a toner image is formed in printer section 105, and ejects the transfer sheet with an image formed thereon.

Host apparatus 2 is made of an input section including a keyboard, mouse and others, a communications control section for connecting host apparatus 2 to image forming apparatus 1, LCD and others. It is a terminal apparatus such as a PC (personal computer) equipped with an image display section, image data storage section and others. When the image data to be printed by image forming apparatus 1 through the input section, and the printing condition settings (transfer sheet size, the number of prints, the number of printed pages, use/non-use of full bleed printing mode, use/non-use of marginal area trimming operation, etc.) have been inputted, host apparatus 2 adds the print setting conditions to the image data as the control data. When the full bleed printing mode is designated, the image data and control data having a size greater than that of the transfer sheet used in the full bleed printing mode is sent to image forming apparatus 1 through the communications control section.

If the image data having the size equal to or smaller than that of the transfer sheet used in the full bleed printing mode has been sent from host apparatus 2, a device may be provided to ensure that the size of the image data received by image forming apparatus 1 will be increased to the size greater than that of the transfer sheet to be used.

The following describes the operation.

FIG. 7 shows the processing of image formation control to be implemented by CPU 101. This processing is carried out when the operation mode and various printing condition settings (transfer sheet size, etc.) are inputted through communications control section 108 or operation display section 102, and image formation request is inputted. It is implemented by software processing through collaboration between CPU 101 and the image formation control processing program stored in storage section 107. The control section is implemented when this processing is carried out. Referring to FIG. 7, the following describes the processing of image formation control.

In the first place, image data is inputted through communications control section 108 or scanner section 103 (Step S1). When the image data has been inputted, the first image processing program is read from storage section 107. Then conversion from brightness linear to concentration linear of the image data having been inputted, and conversion from the R, G and B image data to the C, M, Y and K image data are performed (Step S2).

This is followed by the step of determining if the operation mode is set to the full bleed printing mode or not. If it is not set to the full bleed printing mode (Step S3: No), processing goes to Step S6. If it is set to the full bleed printing mode (Step S3: Yes), the transfer sheet arrangement area of the image data is determined according to the image data having been inputted, namely, the image data for full bleed printing mode and transfer sheet size (Step S4). The image trimming program is read from storage section 107, and image trimming is performed (Step S5).

In the full bleed printing mode, as described above, the size of the image data for full bleed printing mode is normally greater than that of the transfer sheet size. This arrangement ensures a toner image to be formed over the entire transfer sheet despite variations among machines. Such being the case, toner necessarily runs off the transfer sheet at the time of transfer. However, the toner running off the edge is transferred to the secondary transfer roller, and is moved to the pressure section by the rotation of the secondary transfer roller. It adheres to the rear of the transfer sheet being transferred or the succeeding transfer sheet. In this way, the rear of the transfer sheet is contaminated, with the result that the finished quality is deteriorated. The problem of contamination on the rear resulting from the toner running off the side edge in the direction of conveyance can be solved by improving the conveyance accuracy so that the transfer sheet will not be skewed by conveyance. The problem of contamination on the rear resulting from toner running off the trailing edge in the direction of conveyance can be solved by releasing the pressure contact between intermediate transfer belt and secondary transfer roller or by cleaning after formation of the image. However, the problem of contamination on the rear resulting from the toner running off the leading edge in the direction of conveyance cannot be solved by improving the conveyance accuracy, releasing the pressure contact or cleaning after formation of the image. This presents a serious problem.

To solve the aforementioned problem, CPU 101 of the image forming apparatus 1 provides control in such a way that image trimming is implemented; an image is formed so that a marginal area is formed on the side positioned at the leading edge of the transfer sheet in the direction of conveyance; and the toner does not run off the leading edge of the transfer sheet, despite variations having occurred to the machine. In a similar manner as above, the marginal area can be formed on the side edge or the trailing edge of the transfer sheet in the direction of conveyance, thereby preventing the rear from being contaminated. Trimming is intended to ensure that toner image will not be formed on the leading edge side relative to the trimming position in the process of image formation based on the data. If there is no variation among the machines such as that stored in variation parameter storage section 107a, the trimming position of the image data is the position corresponding to the leading edge of the transfer paper in the image data area; namely, the position of the leading edge of the aforementioned transfer sheet arrangement area. Actually, however, the position of the leading edge of the transfer sheet may be misaligned with the position of the leading edge of the transfer sheet arrangement area due to the variations. Thus, the toner may run off the leading edge of the transfer sheet so that the rear of the transfer sheet is contaminated. This may produce an image of poor finished quality. To avoid this possibility, in the image trimming operation of the Step S5, a position is selected wherein the marginal area on the transfer sheet will be minimized to ensure that toner does not run off the leading edge of the transfer despite the variations among the machines and to ensure the high quality in the full bleed printing mode. This position is determined as the trimming position. This trimming position is used to perform trimming operation on the image leading edge.

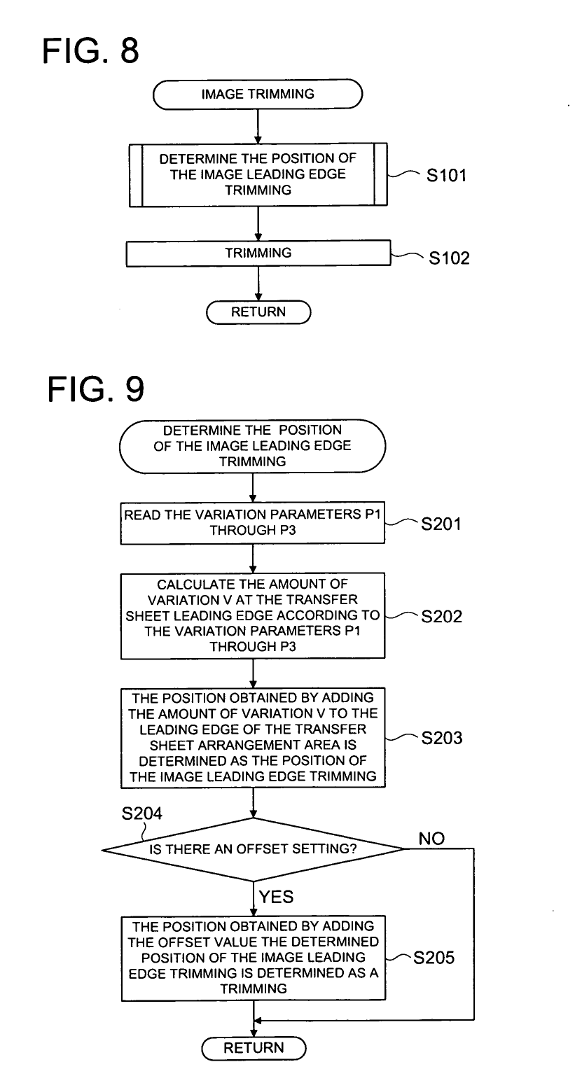

FIG. 8 shows the image trimming operation to be performed by CPU 101 in the Step S5. The following describes the steps of image trimming in details. In the image trimming, first of all, processing of determining the position for the image leading edge trimming is implemented (Step S101).

FIG. 9 shows the processing of determining the position for the image leading edge trimming. In the first place, the following parameters are read from variation parameter storage section 107a (Step S201): position error P1 between the position of the leading edge of the transfer sheet and the position of the image forming position during transfer sheet conveyance; the amount of change P2 in the toner image size in the transfer sheet conveyance direction resulting from the variations in the intermediate transfer belt drive speed; and the amount of change P3 in the toner image size in the transfer sheet conveyance direction resulting from the variations in registration roller drive speed.

The amount of variation V at the position of the leading edge of the transfer sheet is calculated according to the variation parameters P 1 through P 3 having been read (Step S202).
V=P1+P2+P3 (calculation formula)

Then P 1 through P 3 stored in variation parameter storage section 107a is used for calculation. This will yield 0.52 mm as the maximum amount of variation.

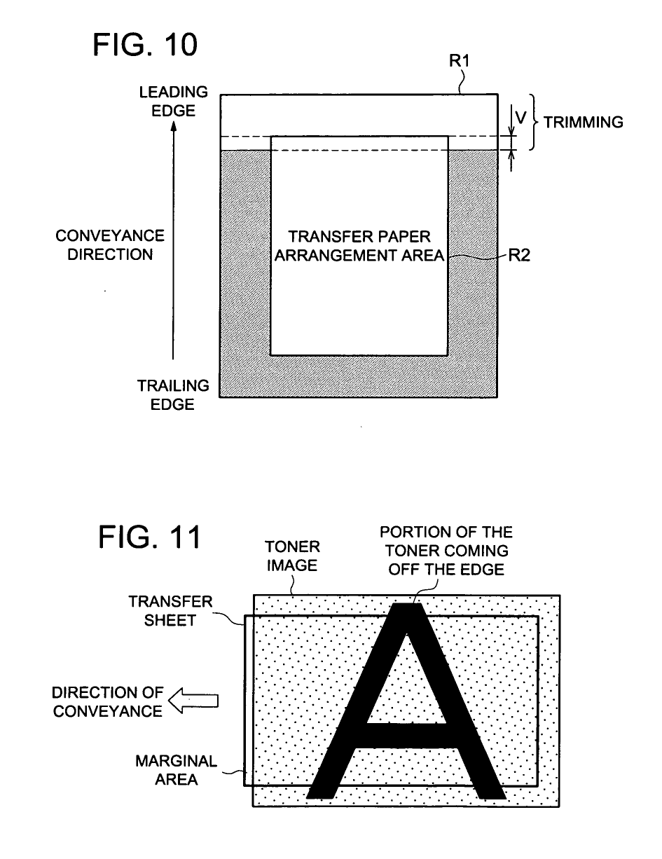

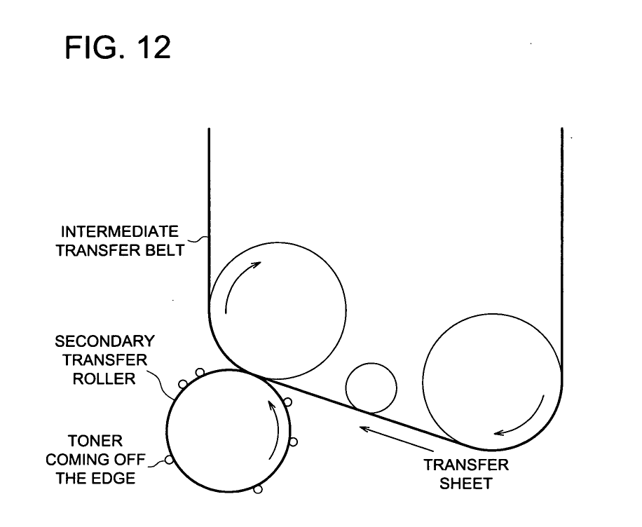

When the amount of variation V has been calculated, the position obtained by adding the amount of variation V to the leading edge position of the transfer sheet arrangement area is determined as the position of the image leading edge trimming (Step S203). FIG. 10 schematically shows the position of the image leading edge trimming. The position of the leading edge of the transfer sheet at the time of image formation may vary within the range of the amount of variation V with reference to the leading edge position of the transfer sheet arrangement area indicated by R2. If an image is trimmed at the position obtained by adding the amount of variation V to the leading edge position of the transfer sheet arrangement area indicated by R2, toner does not run off the leading edge of the transfer sheet, and high quality in full bleed printing mode is ensured with the marginal area kept at the minimum, even if the actual position of the leading edge of the transfer sheet has been displaced by the amount of variation V from the leading edge position of the transfer sheet arrangement area.

When the offset value is stored in offset value storage section 107b (Step S204: Yes), the position obtained by adding the offset value to the position determined in the Step S203 is determined as the position of the image leading edge trimming (Step S205).

Going back to FIG. 8, assume that the position of the image leading edge trimming has been determined. Then image data is trimmed at the position of the image leading edge trimming having been determined (Step S102). Image data can be trimmed by various methods; for example, a method of trimming the leading edge side relative to the position of the image leading edge trimming in the image data,

a method of storing the image data after the position of the image leading edge trimming when image data is stored in the DRAM of the image memory section 104,

and a method of converting the image data on the leading edge side relative to the position of the image leading edge trimming into the density data (0×ff at 8-bit gradation) where toner cannot be transferred.

Upon completion of image data trimming, the system proceeds to the Step S6 of FIG. 7. The image data of the DRAM of image memory section 104 is displayed (Step S6), and the second image processing program is read from storage section 107. When the γ curve is applied to the image data, the output characteristics of the printer section 105 are corrected (Step S7). The image data having been subjected to image processing is output to printer section 105. According to the image processed image data, a toner image is formed on the transfer sheet at printer section 105 (Step S8). FIG. 11 shows the relationship between the toner image and transfer sheet at the time of transfer in printer section 105. When the image is trimmed in the Step S5, a marginal area is formed on the leading edge side of the transfer sheet in the direction of conveyance, as shown in FIG. 11. Then the leading edge of the toner image is located backward in the conveyance direction relative to the leading edge of the transfer sheet. This will prevent a toner image from running off the leading edge of the transfer sheet.

Upon completion of image formation in printer section 105, a decision step is taken to determine whether trimming of the marginal area on the leading edge side of the transfer sheet has been set or not. If trimming of the marginal area on the leading edge side of the transfer sheet has not been set (Step S9; No), the transfer sheet with an image formed thereon is conveyed to finishing apparatus 111, and is outputted from the sheet ejection tray of finishing apparatus 111 (Step S10). This processing is now complete. If trimming of the marginal area on the leading edge side of the transfer sheet has been set (Step S9; Yes), the transfer sheet with an image formed thereon is conveyed to finishing apparatus 111. In finishing apparatus 111, the transfer sheet with the image formed thereon is trimmed at the position corresponding to the width corresponding to the amount of variation V (the width obtained by adding the offset value if any) from the leading edge of the transfer sheet (Step S11). The trimmed transfer sheet is outputted from the sheet ejection tray of finishing apparatus 111 (Step S12). This processing is now complete.

As described above, image forming apparatus 1 calculates the amount of variation V in the leading edge of the transfer sheet in the full bleed printing mode, based on the timing error P1 between the position of the leading edge of the transfer sheet and the image forming position during the conveyance of the transfer sheet; the amount of change P2 of the toner image size in the transfer sheet conveyance direction resulting from the variations in the intermediate transfer belt drive speed; and the amount of change P3 of the toner image size in the transfer sheet conveyance direction resulting from the variations in registration roller drive speed. In the image data, the position obtained by adding the amount of variation V to the position of the leading edge of the transfer sheet arrangement area corresponding to the transfer sheet in the image formation process is determined as the position of the image leading edge trimming. The image data is trimmed at the determined position, and the toner image is formed on the transfer sheet based on the image data after the position of the image leading edge trimming and is outputted. This procedure results in outputting an image with a marginal area formed on the side located at the leading edge of the transfer sheet in the direction of conveyance.

The aforementioned arrangement ensures that, despite variations among the machines, toner does not run off the leading edge of the transfer sheet, and the rear of the transfer sheet is not contaminated. Further, the marginal area is kept to a minimum, and excellent finishing quality is provided in the full bleed printing mode. This ensures improved image quality in the full bleed printing mode.

The aforementioned description of the embodiment refers to a preferred example of image forming apparatus 1 the embodiment of the present invention, without being restricted thereto.

In the aforementioned embodiment, for example, a marginal area is provided on the leading edge side of the transfer sheet in the direction of conveyance to prevent toner from running off the leading edge of the transfer sheet. However, the side edge of the transfer sheet in the transfer sheet conveyance direction cannot be cleaned until a toner image for one sheet is transferred onto the transfer sheet. Further, the pressure and the contact of the secondary transfer roller is not released. To solve this problem, a marginal area can be provided to prevent toner from running off the edge. Further, a marginal area can be provided on the trailing edge of the transfer sheet in the conveyance direction in order to minimize the amount of wasted toner and to prevent toner from running off the edge.

In the aforementioned embodiment, for example, the amount of variation V is calculated at every step of image formation. It is also possible to arrange such a configuration that the processing of determining the position for the aforementioned image leading edge trimming is implemented at the time of installing or manufacturing the image forming apparatus 1, the trimming position is determined, and the trimming position which has been determined is stored in storage section 107 in advance. This procedure eliminates the need of calculating the amount of variation V at every step of image formation, and reduces the time of processing. If the offset value has been set, the position of the image leading edge trimming with allowances made for the offset value can be determined easily by adding the offset value to the preset trimming position at the time of image formation.

In image forming apparatus 1, if the image is trimmed at 0.52 mm from the leading edge of the transfer sheet arrangement area toward the trailing edge, toner is prevented from running off the leading edge of the transfer sheet. There may be a slight change in the amount of variation V according to the individual differences among image forming apparatuses. When allowances are made for the change in the amount of variation V according to the individual differences among image forming apparatuses, the position of the image leading edge trimming is preferably determined at 0.52 mm or more without exceeding 2 mm from the leading edge of the transfer sheet arrangement area according to the experiments and experience. To be more specific, the position of the image leading edge trimming is preferably determined at 0.52 mm or more without exceeding 2 mm from the leading edge of the transfer sheet arrangement area. When the trimming position is stored in storage section 107 in advance, it is preferably stored within the range of 0.52 mm or more without exceeding 2 mm from the leading edge of the transfer sheet arrangement area.

The following arrangement can also be used: The test pattern of the image data for full bleed printing is stored in storage section 107, and a test print designation button is provided on the offset adjustment screen for designation of test printing. When the offset value has been set from this test print designation button, the test pattern stored in storage section 107 is printed in the full bleed printing mode, and is outputted. This arrangement allows the user to make easy offset adjustment for the width of the marginal area formed on the leading edge of the transfer sheet and the width of the toner image running off the edge.

The aforementioned embodiment has been explained with reference to an example wherein the present invention is applied to the color image forming apparatus. The present invention can also be applied to the monochromatic image forming apparatus. The present embodiment has been described with reference to an example of the image forming apparatus wherein toner image formed on the photoreceptor drum is transferred to the transfer sheet through the intermediate transfer belt. The present invention can also be applied to the image forming apparatus wherein toner image is transferred to the transfer sheet directly from the photoreceptor drum.

Further, the detailed structure and detailed operation of various apparatuses constituting the image forming apparatus 1 can be embodied in a great number of variations with appropriate modification or additions, without departing from the technological spirit and scope of the invention claimed.

According to the aforesaid embodiment, it prevents the rear of the recording medium from being contaminated by the toner running off the edge on at least one side of the recording medium, thereby ensuring the improved quality.

Also, it securely prevents the rear of the recording medium from being contaminated by the toner running off the edge on at least the side of the leading edge of the recording medium in the conveyance direction wherein cleaning cannot be performed until the completion of image formation on one sheet, and the toner running off the edge of a transfer sheet directly contaminate the rear of the recording medium. Thus, optimization of the finished quality and productivity is ensured.

Also, it prevents the rear of the recording medium from being contaminated by the toner running off the edge on the side of the leading edge of the recording medium in the conveyance direction wherein cleaning cannot be performed until the completion of image formation on one sheet, and the toner running off the edge of a transfer sheet directly contaminate the rear of the recording medium. Thus, optimization of the finished quality and productivity is ensured.

Also, it prevents the rear of the recording medium from being contaminated by the toner running off the edge on at least one of the sides of the recording medium, despite such mechanical changes as:

the positioning deviation between the position of the reading edge of the recording medium while the recording medium is being conveyed and the starting position of image forming on the recording medium,

the change of the size of the toner image in the recording medium conveyance direction resulting from the fluctuation of toner image conveyance speed, and

the change of the size of the toner image in the recording medium conveyance direction resulting from the fluctuation of recording medium conveyance speed.

Also, it allows the user to adjust the width of the marginal area from one side recording medium.

Also, it allows the user to make adjustment so that the marginal area will be reduced, or that a toner image from one side of the recording medium will run off the edge when the user is not concerned about the contamination on the rear of the recording medium.

What is claimed is:

1. An image forming apparatus, comprising:
a control device which controls forming of a marginal area at least on one of sides of a recording medium in a full bleed printing mode, in which a toner image is formed and outputted based on an image data whose size is grater than that of a recording medium used for image forming through electricphotographing process on an entire area of the recording medium.

2. The image forming apparatus of claim 1, wherein the control device controls to form the marginal area at least on a side located on a leading edge of the recording medium in a conveyed direction, out of the sides of recording medium in the full bleed printing mode.

3. The image forming apparatus of claim 1, wherein the control device controls to form the marginal area only on a side located on a leading edge of the recording medium in a conveyed direction, out of the sides of recording medium in the full bleed printing mode.

4. The image forming apparatus of claim 1, wherein the control device controls to form the marginal area based on at least one of the items of information on
a positioning deviation between a position of the reading edge of the recording medium while the recording medium is being conveyed and a starting position of image forming on the recording medium,
a change of a size of a toner image in a recording medium conveyance direction resulting from a fluctuation of toner image conveyance speed, and
a change of a size of a toner image in the recording medium conveyance direction resulting from a fluctuation of recording medium conveyance speed.

5. The image forming apparatus of claim 4, wherein the change of the size of the toner image in the recording medium conveyance direction resulting from a fluctuation of toner image conveyance speed is an amount of change of the size of the toner image in the recording medium conveyance direction.

6. The image forming apparatus of claim 4, wherein the change of the size of the toner image in the recording medium conveyance direction resulting from a fluctuation of recording medium conveyance speed is an amount of change of the size of the toner image in the recording medium conveyance direction.

7. The image forming apparatus of claim 4, comprising:
an intermediate transfer belt,
wherein the fluctuation of toner image conveyance speed is a fluctuation of rotation speed of the intermediate transfer belt.

8. The image forming apparatus of claim 4, comprising:
a registration roller,
wherein the fluctuation of recording medium conveyance speed is a fluctuation of rotation speed of the registration roller.

9. The image forming apparatus of claim 1, comprising:
an adjusting device which adjusts a width of the margin area from one side of the recording medium in response to demands from input operation of a user.

10. The image forming apparatus of claim 9, wherein the adjusting device is capable of increasing and decreasing of the width of the margin area.

11. A computer program for controlling an image forming apparatus, comprising the function of:
a marginal area forming function which realizes the image forming apparatus to control forming of the marginal area at least on one of sides of the recording medium in a full bleed printing mode, in which a toner image is formed and outputted based on an image data whose size is grater than that of a recording medium used for image forming through electricphotographing process on an entire area of the recording medium.

12. The computer program of claim 11, wherein in the marginal area forming function, the marginal area is formed at least on the side located at the leading edge of the recording medium in a recording medium conveyance direction, out of the sides of the recording medium.

13. The computer program of claim 11, wherein in the marginal area forming function, the marginal area is formed on only the side located at the leading edge of the recording medium in the conveyance direction, out of the sides of the recording medium.

14. The computer program of claim 11, in the marginal area forming function, the marginal area is formed based on at least one of the items of information on
a positioning deviation between a position of the reading edge of the recording medium while the recording medium is being conveyed and a starting position of image forming on the recording medium,
a change of a size of a toner image in a recording medium conveyance direction resulting from a fluctuation of toner image conveyance speed, and
a change of a size of a toner image in the recording medium conveyance direction resulting from a fluctuation of recording medium conveyance speed.

15. The computer program of claim 14, wherein the change of the size of the toner image in the recording medium conveyance direction resulting from a fluctuation of toner image conveyance speed is an amount of change of the size of the toner image in the recording medium conveyance direction.

16. The computer program of claim 14, wherein the change of the size of the toner image in the recording medium conveyance direction resulting from a fluctuation of recording medium conveyance speed is an amount of change of the size of the toner image in the recording medium conveyance direction.

17. The computer program of claim 14, wherein the change in the toner image conveyance speed is the change in an intermediate transfer belt drive speed.

18. The computer program of claim 14, wherein the change in the recording medium conveyance speed is the change in a registration roller rotation speed.

19. The computer program of claim 11, further comprising the function of:
an adjusting function which realizes the image forming apparatus to adjust a width of the marginal area from one side of the recording medium in response demands from input operation of a user.

20. The computer program of claim 19, wherein the adjusting function is capable of increasing adjustment and decreasing adjustment of the width.
